(19) United States
(12) Patent Application Publication
(10) Pub. No.: US 2025/0195925 A1
(43) Pub. Date: Jun. 19, 2025

(54) FIRE FIGHTING ELECTRIC VEHICLE COOLING SLED

(71) Applicant: Joseph Patrick Lenahan, Montauk, NY (US)

(72) Inventor: Joseph Patrick Lenahan, Montauk, NY (US)

(21) Appl. No.: 18/610,845

(22) Filed: Mar. 20, 2024

Related U.S. Application Data
(60) Provisional application No. 63/609,963, filed on Dec. 14, 2023.

(51) Int. Cl. A62C 3/07; A62C 99/00

(52) U.S. Cl. CPC A62C 3/07; A62C 99/0072

(57) ABSTRACT

The present invention is directed towards a cooling sled for distributing water to suppress of eliminate a fire in the battery compartment of an electric vehicle.

### CROSS-REFERENCE TO RELATED APPLICATION

This application claims the benefit of priority of U.S. provisional application No. 63/609,963, filed Dec. 14, 2023, the contents of which are herein incorporated by reference.

### BACKGROUND OF THE INVENTION

Fires in lithium-ion battery packs, particularly those in electric vehicles, are very difficult to extinguish. Such fires often result in thermal runaway. In the context of lithium-ion batteries, and in particular those used in electric vehicles, thermal runaway occurs when the heat generated by the battery exceeds the rate at which it can dissipate heat. This can be triggered by factors such as overcharging, internal short circuits, damage due to collision, or manufacturing defects. As the temperature rises, it can lead to increased chemical reactions within the battery, generating even more heat in a feedback loop. This cycle can result in a rapid and uncontrolled rise in temperature, potentially leading to the release of gases, fire, or even explosions.

The present invention is directed at preventing thermal runaway of an electric vehicle lithium-ion battery compartment, particularly when it is damaged, overcharged or catches on fire. The present invention will help control the rise in temperature inside the lithium-ion battery compartment to help reduce or eliminate the possibility of thermal runaway.

Conventional devices on the market do not deploy enough water to the surface of the battery box that needs to be cooled. Such devices also often puncture the battery box under the vehicle, which is directly contrary to the first responder's information published on most EV vehicle manufacturers web sites.

The present invention is directed at improvements to the currently available products. In a preferred embodiment, the present invention is directed towards a Cooling Sled that has minimal moving parts and which utilizes more water distribution which allows an increased water supply to reach the battery compartment.

In addition to addressing problems with conventional products and systems as noted above, the present invention can also be utilized in connection with other potentially dangerous situations, such as cooling an above ground liquid propane tank when compromised by fire. This can be completed by sliding the cooling sled of the present invention underneath a liquid propane tank which allows water from the cooling sled to spray water to the underside of the tank to keep it cool, so such tank does not get compromised from excessive heat.

### SUMMARY OF THE INVENTION

In a preferred embodiment, the present invention is directed towards a Cooling Sled that can be positioned under a vehicle that has a battery compartment that has been damaged or overcharged or is otherwise at risk of a thermal runaway event. In a preferred embodiment, the cooling sled of the present invention will deploy cool water from a water source onto the surface of the lithium-ion battery box enclosure under such vehicle without puncturing or otherwise damaging the battery compartment.

In one aspect of the present invention, the cooling sled of the present invention comprises multiple high-volume water nozzles connected together and installed on a movable sled-like device that can easily be positioned beneath the battery compartment of an electric vehicle.

These and other features, aspects and advantages of the present invention will become better understood with reference to the following drawings, description, and claims.

### BRIEF DESCRIPTION OF THE DRAWINGS

FIG. 1 depicts a perspective view of a cooling sled constructed in accordance with a preferred embodiment of the present invention.

FIG. 2 depicts a top view of the cooling sled of FIG. 1 with the lid removed.

FIG. 3 depicts an exploded view of the primary piping components shown in FIG. 2.

FIG. 4 depicts the cooling sled of FIG. 1 positioned next to a vehicle.

FIG. 5 depicts the cooling sled of FIG. 1 deployed underneath a vehicle.

FIG. 6 depicts a cross sectional side view of the cooling sled of FIG. 2 taken along the line 6-6.

FIG. 7 depicts a side view of the cooling sled of FIG. 1 with an associated water source connected thereto.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The cooling sled of the present invention can help prevent thermal runaway of an electric vehicle lithium-ion battery compartment, such as when it is damaged, overcharged or catches on fire. The cooling sled of the present invention can also help cool above ground liquid propane tanks when compromised from fire. The invention claimed here solves these and other problems associated with conventional systems and methods.

In one aspect of the present invention, the cooling sled of the present invention comprises multiple high-volume water nozzles connected together and installed on a movable sled-like device that can easily be positioned beneath the battery compartment of an electric vehicle that has been damaged, or overcharged, or otherwise being susceptible to a thermal runaway event, and can deploy cool water from a water source onto the surface of the lithium-ion battery box under the vehicle without penetrating the battery compartment.

The claimed invention differs from what currently exists. The cooling sled of the present invention has minimal mechanical moving parts. Other conventional devices utilize water and air to operate while puncturing the lithium-ion battery box, which is contrary to the first responder's information published on most EV vehicle manufacturers web sites. In addition, conventional devices do not supply enough water to the surface to cool the battery compartment from possible thermal runaway.

Contrary to conventional systems, the cooling sled of the present invention, as disclosed herein and as depicted in the accompanying drawings, utilizes greater water distribution that allows for a greater water supply to reach the battery compartment while having minimal moving parts. In an alternative preferred embodiment, the cooling sled of the present invention can also distribute firefighting foam that would be distributed from a fire apparatus through the water supply line into the cooling sled.

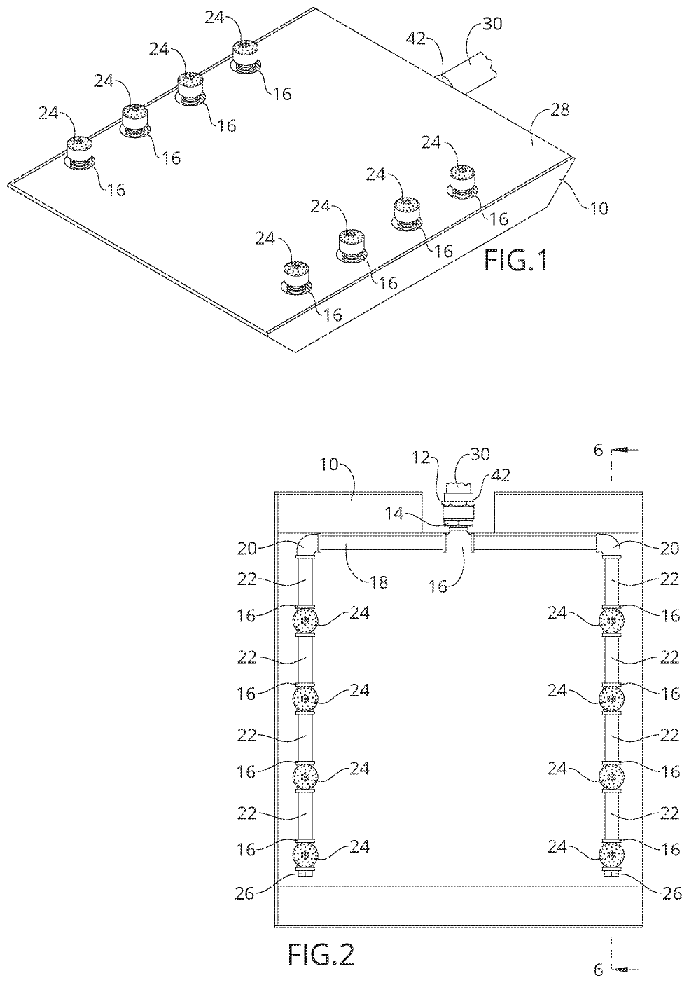

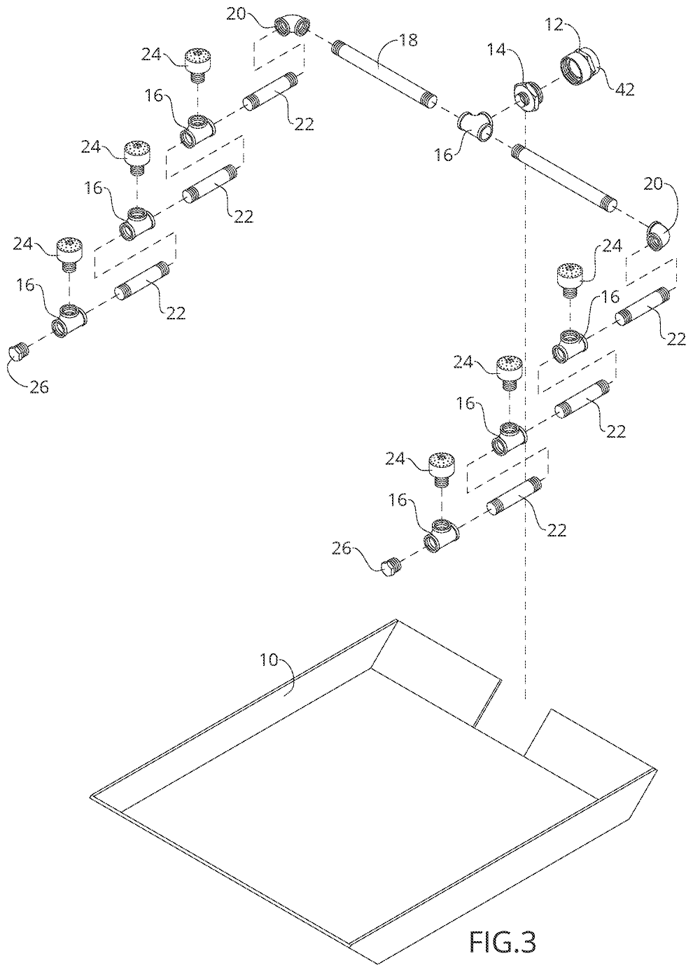

As seen in FIGS. 1 through 7 (and in particular FIG. 1 and FIG. 3), the cooling sled 10 is a generally square-shaped housing that has a bottom, side walls, and a top 28. As seen in FIG. 2, by way of example, a water supply line 30 is connected to the pipes 22 within the sled 10 via a camlock connector 42, and hose connector 12, and hose connector adapter 14. Hose connector 12 is connected to tee 16 for distributing the water into two branches, one to the left (left side of FIG. 2) and one to the right (right side of FIG. 2) via pipes 18. Long pipes 18 are connected to elbows 20 for further distributing the water down the left and right branches via short pipes 22, tee's 16 and end plugs 26. Multiple valves 24 are placed at the top end of tee's 16 to distribute the water through the top lid 28.

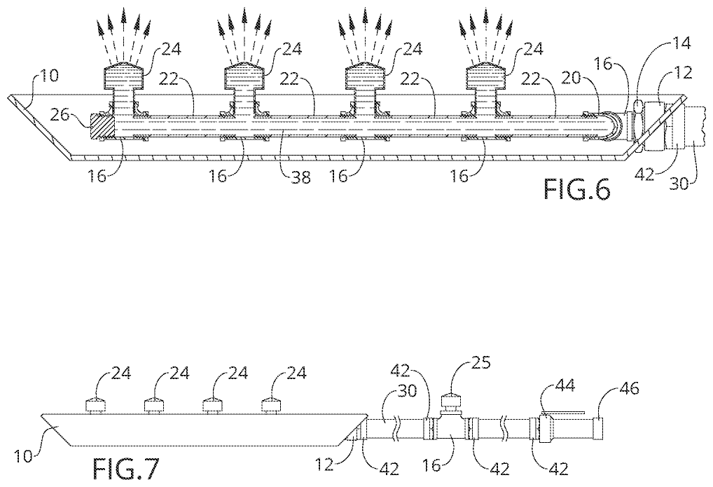

The water is distributed within pipes 22, tee's 16, elbows 20 and then is dispersed from sled 10 via multiple nozzles 24 that are connected to pipes 22 via tees 16. End caps 26 prevent the water from exiting the sled other than through nozzles 24. In a preferred embodiment, there are eight nozzles 24 that are connected to pipes 22 and extend through the lid 28. In a general sense, water is pumped through supply line 30 and is distributed via pipes 22 and tee's 16 to multiple nozzles 24 to the underside of the battery compartment (see FIGS. 5 and 6, by way of example).

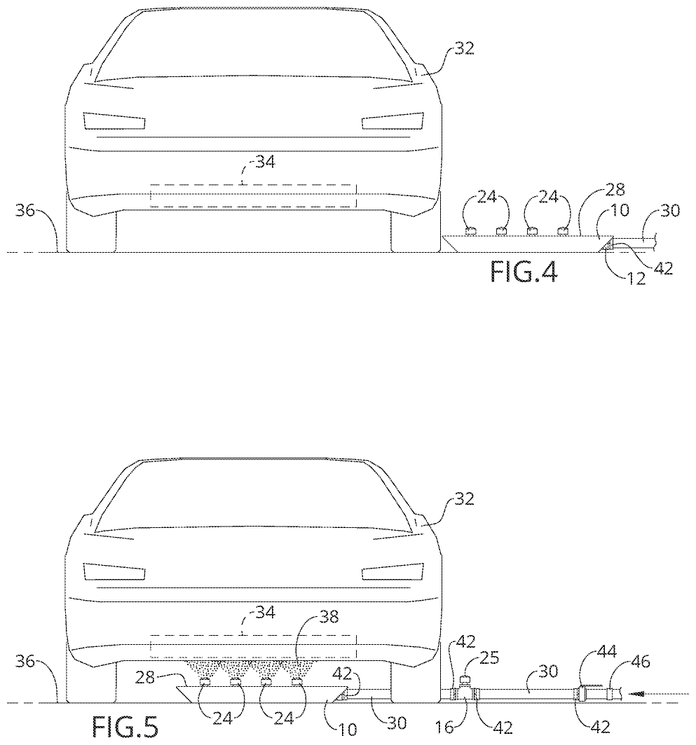

In a preferred embodiment, as seen in FIG. 4 and FIG. 5, in order to deploy the cooling sled of the present invention, sled 10 is positioned on the ground 36 next to a vehicle 32 that has a battery compartment 34 in need of attention. As seen in FIG. 7, supply line 30 is attached to a valve 44 for controlling the water supply from hose connection 46, and supply line 30 also includes a feeding nozzle 25 connected to supply line 30. Sled 10 can then be positioned below vehicle 32 and underneath battery compartment 34. Once the water 38 is turned on via valve 44, the water enters sled 10 and is distributed through pipes tee's 16, pipes 22, elbows 20 and ultimately exits sled 10 via nozzles 24 to be sprayed on battery compartment 34 (see FIGS. 4-6).

In a preferred embodiment, sled 10 is generally square shaped and made of aluminum, but other materials and shapes are contemplated without departing from the spirit of the invention. In addition, in a preferred embodiment, the various pipes, tee's, elbows and nozzles are made primarily of brass, although other materials (cast iron, copper, aluminum, steel, plastic, etc.) are contemplated without departing from the spirit of the invention. In a preferred embodiment, nozzles 24 are mushroom shaped water distribution heads, and valve 44 is an On/Off Brass IPS Full Port Ball Valve. Sled 10 may also include wheels or other types of rolling devices (not shown) on the bottom or sides of the sled to aid in positioning sled 10 underneath vehicle 32 along the ground 36.

As described herein, and as seen in FIGS. 1-7, cooling sled 10 is made up of minimal moving components. The included components are primarily aluminum female swivel fire hose adapters, brass On/Off valve, brass piping and brass mushroom water distribution heads that sit inside a custom aluminum box (sled).

Once a 1.75″ water supply line is connected to the aluminum female swivel adapter, the On/Off valve is turned to the ON position so that water can flow through the brass piping that makes up the body of cooling sled 10 which in turn distributes water through the brass mushroom heads 24 allowing water to spray in multiple directions to cool the object. A separate distribution pipe (not shown) or positioning device can be added to the cooling sled to safely position the device under a vehicle or liquid propane tank from a safe distance.

Cooling sled 10 of the present invention has many uses. In a preferred embodiment, it is designed for the fire service so that a single firefighter or team of firefighters can deploy the sled to cool or suppress a fire under a vehicle, to cool an above grade LP tank if compromised from fire, or to cool a raised mobile home that is on fire, by way of example. Cooling sled 10 will safely allow firefighters to distribute water without climbing under such areas, which would be dangerous and potentially life-threatening. Additionally, cooling sled 10 can be utilized in mobile home fires, basement fires, LP/Oil truck fires, LP tank fires, as well as for Haz-Mat decontamination. Also, cooling sled 10 can also be used to distribute firefighting foam that would be distributed from a fire apparatus through the water supply line into the cooling sled.

It should be understood, of course, that the foregoing relates to exemplary embodiments of the invention and that modifications may be made without departing from the spirit and scope of the invention as set forth in the following claims.

What is claimed is:

1. A cooling sled for preventing thermal runaway of an electric vehicle lithium-ion battery compartment, the cooling sled comprising:
a housing having a bottom, sides and a top and including;
a first tee having a first opening for connecting a water supply to the sled,
a second opening for connecting a left leg pipe, and a third opening for connecting a right leg pipe;
the left leg pipe being connected to a left elbow for distributing water along the left side of the sled;
the right leg pipe being connected to a right elbow for distributing water along the right side of the sled;
the left elbow being connected to a left side pipe, which is connected to a left side tee, the left side tee being connected to the left side pipe at one opening, a second left side pipe at a second opening, and a left side water distribution nozzle at the third opening;
the left side water distribution nozzle extending through the top of the housing for distributing water to a battery compartment of a an electric vehicle;
the right elbow being connected to a right side pipe, which is connected to a right side tee, the right side tee being connected to the right side pipe at one opening, a second right side pipe at a second opening, and a right side water distribution nozzle at the third opening;
the right side water distribution nozzle extending through the top of the housing for distributing water to a battery compartment of a an electric vehicle.

2. The cooling sled of claim 1, further comprising:
a second tee connected to the second left side pipe, the second tee being connected to a second left side nozzle; and
a second tee connected to the second right side pipe, the second tee also being connected to a second right side nozzle.

3. The cooling sled of claim 1, wherein the water supply is connected to the sled via a camlock fitting.

4. The cooling sled of claim 1, wherein the nozzles comprise mushroom shaped water distribution heads.

5. The cooling sled of claim 1, wherein the water supply also comprises a feedline nozzle.
